(19) United States
(12) Patent Application Publication
(10) Pub. No.: US 2016/0201342 A1
(43) Pub. Date: Jul. 14, 2016

(54) Rebar Joint Tie Tool

(71) Applicant: LUTHER SIVADJIAN, Glendale, CA (US)

(72) Inventor: LUTHER SIVADJIAN, Glendale, CA (US)

(21) Appl. No.: 14/596,597

(22) Filed: Jan. 14, 2015

(51) Int. Cl. E04G 21/12; B25C 5/16

(52) U.S. Cl. CPC E04G 21/123; B25C 5/1658

(57) ABSTRACT

A tie installing tool for tying together at least two crossed rods arranged to be non-parallel and touching one another, comprising a tie ejector, an anvil which deforms dispensed ties to encircle the at least two crossed rods, and an actuator operable to move the anvil between a deployed position encircling the at least two crossed rods and a released position from which the tool can be disengaged from the at least two crossed rods. The anvil may comprise two opposing hinged jaws each having a groove therein for deforming one end of a dispensed tie to encircle the at least two crossed rods. The actuator may include a plunger which is displaced when the tie installing tool is pressed against at least one of the two crossed rods, and a linkage which moves the two opposing hinged jaws between the deployed position and the released position.

### FIELD OF THE DISCLOSURE

The present disclosure relates to fastening elongate objects such as reinforcing bar (rebar) in place either to tack the elongate objects together for subsequent welding, or alternatively, as a final fastener when, for example, the elongate objects are subsequently to be embedded in a material such as concrete.

### BACKGROUND

Concrete structures are frequently reinforced with rebar. Individual lengths of rebar are typically placed perpendicularly to one another and cross one another to form a reinforcing skeleton made of rebar. Prior to liquid or uncured cementitious material such as concrete being poured into a form with rebar reinforcing structure therein, individual rebars of the skeleton must usually be held in place. This has traditionally been done by wrapping manually bendable wire around a joint where two or more rebars contact or cross one another. Manually fortifying this rebar joint is time consuming. In a large structure such as a large building, manual formation of these rebar joints can make a significant contribution to the overall costs of construction. There exists a need to reduce the amount of time to fabricate rebar joints in rebar skeleton structures.

### SUMMARY

The present disclosure addresses the above stated situation by providing a tool and a method to form rebar joints expeditiously. To this end, there is disclosed a tie dispensing tool which causes dispensed ties to partially encircle at least two rods, such as rebars of a rebar joint. The tie installing tool comprises a tie ejector, an anvil which deforms dispensed ties to encircle the at least two crossed rods, and an actuator operable to move the anvil between a deployed position encircling the at least two crossed rods and a released position from which the tool can be disengaged from the at least two crossed rods. The tie ejector may be similar to a staple gun. The anvil may comprise two opposing hinged jaws each having a groove therein for deforming one end of a dispensed tie to encircle the at least two crossed rods. The actuator may include a plunger which is displaced by pressing the tie installing tool against the at least two crossed rods, and a linkage which moves the two opposing hinged jaws between the deployed position and the released position. After dispensed tie is applied to and encircles the at least two crossed rods, the anvil is moved to the released position. The tie dispensing tool may then be disengaged from the at least two crossed rods.

### BRIEF DESCRIPTION OF THE DRAWINGS

Various objects, features, and attendant advantages of the present disclosure will become more fully appreciated as the same becomes better understood when considered in conjunction with the accompanying drawings, in which like reference characters designate the same or similar parts throughout the several views, and wherein:

FIG. 1 is a diagrammatic environmental end view of a tie installing tool approaching two crossed rods to be tied together, according to at least one aspect of the disclosure;

FIG. 2 is a diagrammatic environmental end view of the tie installing tool of FIG. 1, shown closed over and engaging the two crossed rods;

FIG. 3 is a side view of a component shown at the upper portion of FIG. 1;

FIG. 4 is a diagrammatic detail view illustrating alignment of ties to be installed with a tie shaping component of the tie installing tool of FIG. 1;

FIG. 5 is a side view of a tie to be installed by the tie installing tool of FIG. 1;

FIG. 6 is a fragmentary detail view of a jaw seen at the lower left of FIG. 1;

FIG. 7 is a diagrammatic detail view of movable components of the tie installing tool of FIG. 2, showing a deployed position;

FIG. 8 is a diagrammatic detail view of the components of FIG. 7, but showing a released position;

FIG. 9 is a perspective view of two rods tied together by the tie installing tool of FIG. 1;

FIG. 10 is a broken away view similar to FIG. 9, but taken at a different angle;

FIG. 11 is a diagrammatic side view of an alternative to a component seen toward the bottom of FIG. 1;

FIG. 12 is a diagrammatic side of an alternative to the component of FIG. 11;

FIG. 13 is a perspective view of a staple magazine exemplary of that shown in FIG. 9;

FIG. 14 is a perspective detail view of a central component of the staple magazine of FIG. 13;

FIG. 15 is a top plan detail view of the component of FIG. 14;

FIG. 16 is an end view of FIG. 14;

FIG. 17 is similar to FIG. 15, but shows adjustment of opposed sections to accommodate staples of different dimensions;

FIG. 18 is similar to FIG. 16, but reflects the adjustment shown in FIG. 17;

FIG. 19 is similar to FIG. 17, but shows a further degree of adjustment;

FIG. 20 is similar to FIG. 18, but reflects the adjustment shown in FIG. 19;

FIG. 21 is a diagrammatic end view of a tie installing tool, according to at least one further aspect of the disclosure;

FIG. 22 is a detail view of the bottom of FIG. 21, showing internal components; and

FIG. 23 is a side view of FIG. 22.

### DETAILED DESCRIPTION

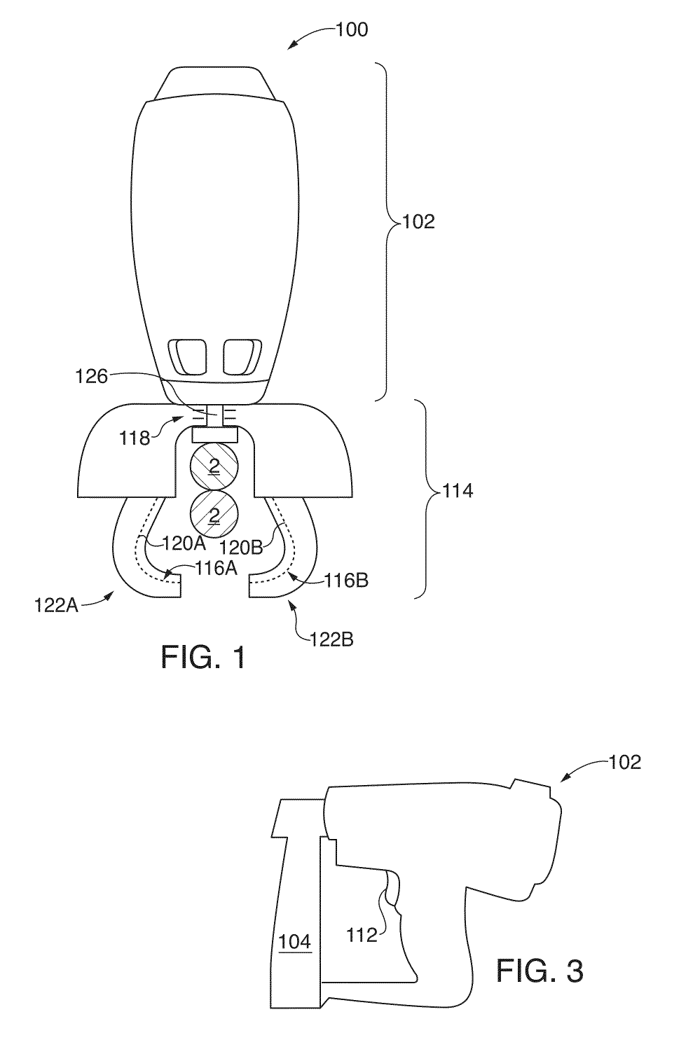

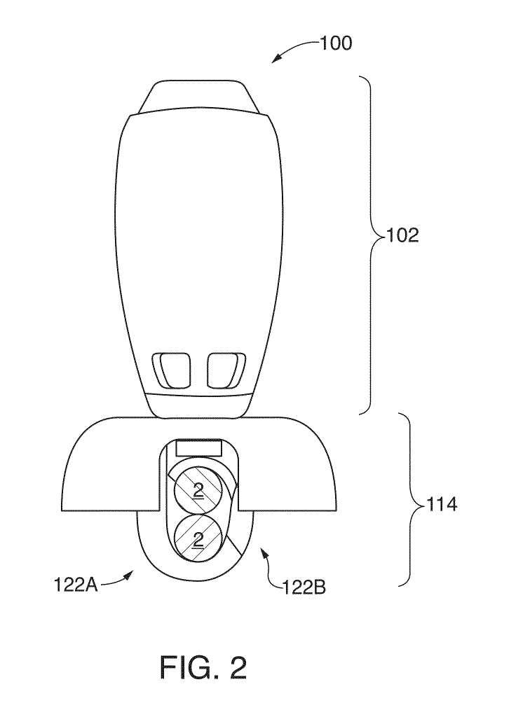

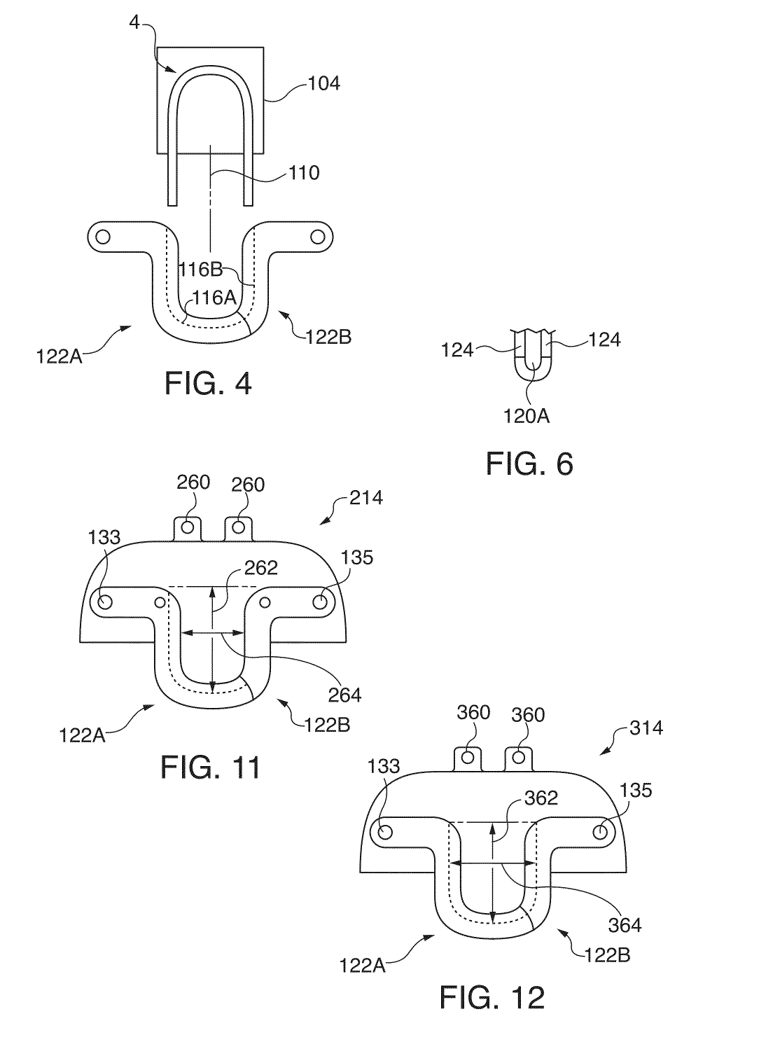

Referring first to FIGS. 1 and 2, according to at least one aspect of the disclosure, there is shown a tie installing tool 100 for tying together at least two crossed rods 2 arranged to be non-parallel and touching one another. Tie installing tool 100 comprises a tie ejector 102 comprising a holder 104 (see FIG. 3) for holding at least one tie 4 (see FIG. 5) having a first end 6 and a second end 8. Tie ejector 108 propels ties 4 from holder 104 along an ejection axis 110 towards the at least two crossed rods 2. Tie installing tool 100 comprises trigger 112 (see FIG. 3) for actuating the tie ejector 102. An anvil assembly 114 is attachably associated with tie ejector 102, comprising a guide surface 116A, 116B movable between a deployed position shown in FIG. 2, wherein the guide surface 116A is linearly aligned with ejection axis 110 of tie ejector 102 (FIG. 4), the anvil assembly 114 partially encircling the at least two crossed rods 2 in the deployed position, and a released position (FIG. 1) enabling the at least two crossed rods 2 to disengage from tie installing tool 100. Guide surface 116A, 116B is configured to deform tie 4 ejected from tie ejector 112 to fully encircle the at least two crossed rods 2. An actuator 118 moves guide surface 116A, 116B from the released position to the deployed position.

Rods 2 may be rebar or other elongate materials which must be mutually joined.

Tie ejector 102 may have structure and function of a pneumatically or electrically powered staple gun (not shown), for example. Trigger 112 controls a motor (not separately shown) to cause tie ejector 102 to eject ties 4.

Ties 4, where tie ejector 102 has structure and function of a staple gun, may be U-shaped staples, as seen in FIG. 3. More particularly, ties 4 may comprise rods which are circular in cross section taken along the length thereof.

Anvil assembly 114 is attachably associated with tie ejector 102 in that it is either removably or permanently attached to tie ejector 102. Where permanently attached to tie ejector 102, tie ejector 2 and anvil assembly 114 may be monolithically formed within a common housing, for example. In the implementation of FIG. 1, anvil assembly 114 is permanently attached to tie ejector 102. In another implementation, anvil assembly 114 is removably attached to tie ejector 102, for example, using threaded fasteners (not shown) to removably join anvil assembly 114 to tie ejector 102.

Anvil assembly 114 comprises a first jaw 122A pivotally mountable to anvil assembly 114 and bearing a first portion 116A of guide surface 116A, 116B, and a second opposed jaw 122B pivotally mountable to anvil assembly 114 and bearing a second portion 116B of the guide surface 116A, 116B. First and second jaws 122A, 122B close over the at least two crossed rods 2 in the deployed position shown in FIG. 2. Also seen in FIG. 2 is that first and second jaws 122A, 122B overlap one another in the deployed position. In FIG. 2, second jaw 122B is partially concealed behind first jaw 122A due to this overlap. In FIG. 2, a portion of first jaw 122A and a portion of second jaw 122B are side by side when overlapping one another.

It should be noted at this point that orientational terms such as above, over, “side by side”, and below refer to the subject drawing as viewed by an observer. The drawing figures depict their subject matter in orientations of normal use, which could obviously change with changes in position. Therefore, orientational terms must be understood to provide semantic basis for purposes of description only, and do not imply that their subject matter can be used only in one position.

Guide surface 116A, 116B is formed in two parts in the implementation of FIG. 1. First jaw 122A has a first groove 120A which defines first portion 116A of the guide surface, receives the first end 6 of a tie 4 being ejected from the tie ejector 102, and deforms a first portion 10 of the tie 4 being ejected to curve around the at least two crossed rods 2. Second jaw 122B has a second groove 120B which defines the second portion 116B of the guide surface 116A, 116B, receives second end 8 of the tie 4 being ejected from tie ejector 102, and deforms a second portion 12 of the tie 4 being ejected to curve around the at least two crossed rods 2. Groove 120A is shown in end view in FIG. 6, groove 120B being similar. Groove 120A is defined between sidewalls 124 so that when a tie 4 enters groove 120A, end 6 is constrained against escape and against resisting deformation as tie 4 is progressively curled as it is ejected from tie ejector 102.

Guide surface 116A, 116B is configured to impart a curl to ties 4 propelled thereagainst by tie ejector 102. With guide surfaces 116A, 116B in the deployed position encircling crossed rods 2 (see FIG. 2), ties 4 will curl around crossed rods 2 when propelled from tie ejector 102.

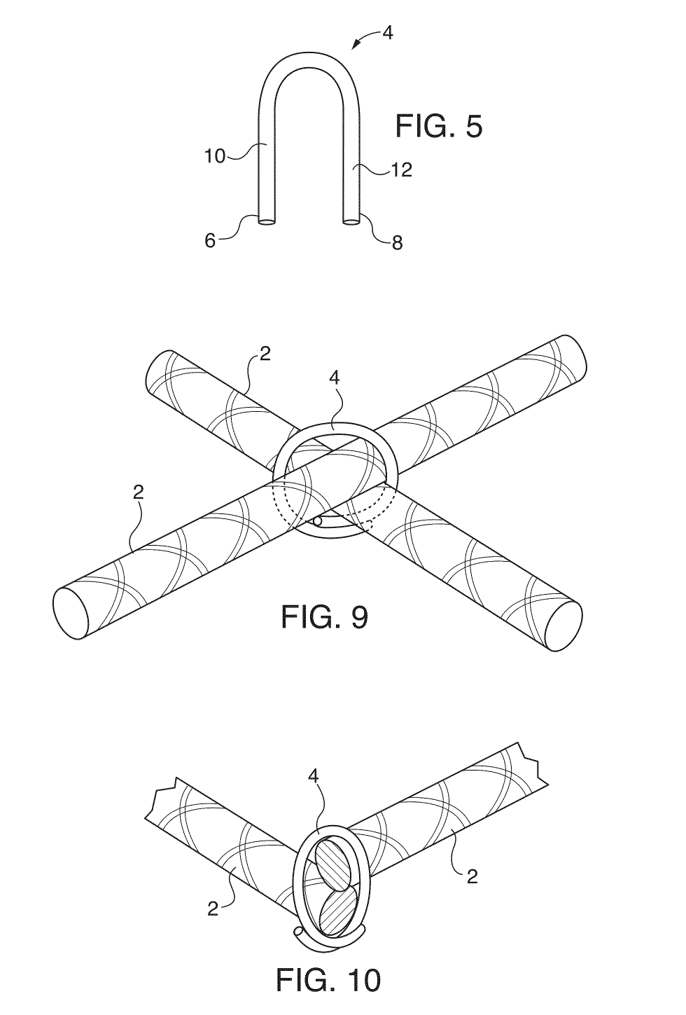

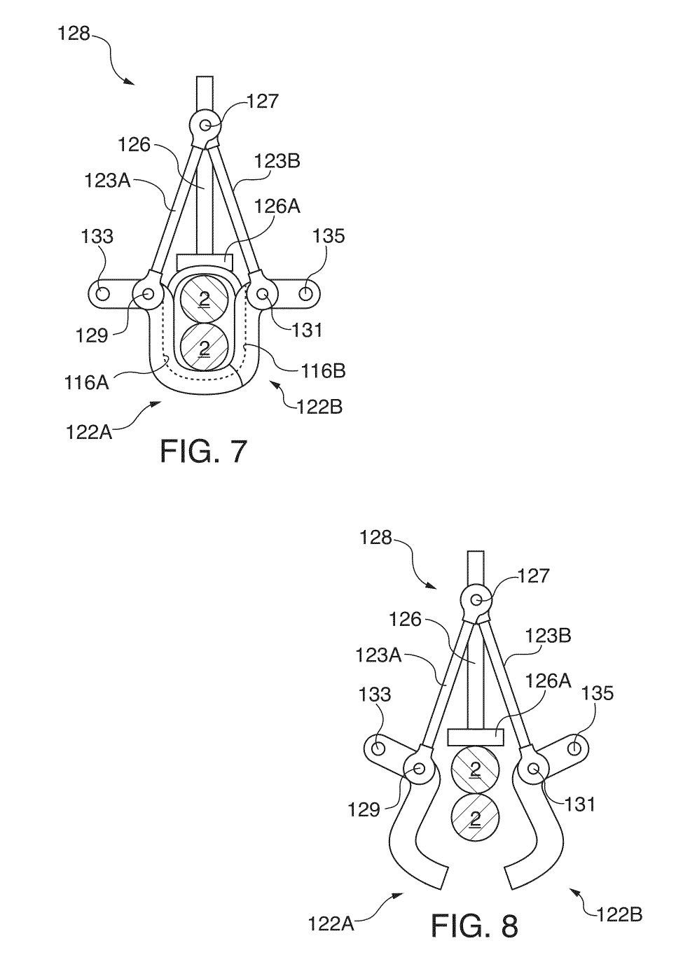

Anvil assembly 114 is controlled as follows. Actuator 118 includes a plunger 126 which is displaced relative to tie installing tool 100 when tie installing tool 100 is pressed against at least one of the two crossed rods 2. A linkage 128 is connected to plunger 126, first jaw 122A, and second jaw 122B. Linkage 128 is arranged to move first jaw 122A and second jaw 122B between the deployed position and the released position responsive to plunger 126 being moved along tie installing tool 100. Referring also to FIGS. 7 and 8, plunger 126 is constrained to translate along a path of motion within tie installing tool 100. This translation, transferred to first and second jaws 122A, 122B by linkage rods 123A, 123B, moves first and second jaws 122A, 122B between the deployed position and the released position.

FIGS. 7 and 8 show components of linkage 128 isolated from stationary components of tie installing tool 100. It will be seen in FIGS. 7 and 8 that plunger 126 includes an enlarged head 126A to assure effective contact with rod(s) 2. Linkage rods 123A, 123B engage plunger 126 at a pivot 127 at one end of each linkage rod 123A or 123B. At their opposed ends, linkage rods 123A, 123B respectively engage first and second jaws 122A, 122B at respective pivots 129, 131.

First and second jaws 122A, 122B are pivotally mounted to anvil assembly 114 at respective pivots 133, 135. Pivots 133, 135 are not shown in their entireties, but will be understood to include a pivot axle fixed within the housing of anvil assembly 114.

When plunger 126 is displaced upwardly from the released position shown in FIGS. 1 and 8, it translates to the deployed position shown in FIGS. 2 and 7, exerting pulling forces on linkage rods 123A, 123B. Responsively, linkage rods 123A, 123B draw first and second jaws 122A, 122B from the released position of FIGS. 1 and 8 to the deployed position of FIGS. 2 and 7, even as tie installing tool is pressed downwardly (as illustrated herein) against rods 2.

When trigger 112 is pulled, a tie 4 is ejected and formed in the guide surface 116A, 116B. This results in tie 4 encircling the two crossed rods 2. FIGS. 9 and 10 show the tied joint of rods 2. If desired, a second tie 4 may be installed around the tied joint at about a right angle to the tie 4 seen installed in FIGS. 9 and 10.

Turning to FIGS. 11 and 12, anvil assemblies 214, 314 are generally structurally and functionally similar to anvil assembly 114 of FIG. 1, with the exception that anvil assemblies 214, 314 include bolt holes 260 or 360 for expeditious attachment to and removal from tie ejector 102, and may have different dimensions. Anvil assembly 214 is a first anvil assembly and is removably mountable to tie installing tool 100. First anvil assembly 214 has first capacity dimensions (represented by arrow 262). Tie installing tool 100 may comprise at least one second anvil assembly 314 having second capacity dimensions (represented by arrow 366) different from the first capacity dimensions of first anvil assembly 214. Width of anvil assemblies 214, 314 (widths indicated by respective arrows 264, 364) may be varied by the manufacturer of tie installing tool 100 if desired.

First and second anvil assemblies 214, 314 are replaceable on tie ejector 102 so that different numbers of rods 2, or different dimensions of rods 2 can be accommodated in that ties 4 may be applied and have a close fit with ties 4 arising from curl imparted by anvil assemblies (e.g., anvil assemblies 114, 214, 314). This allows tie installing tool 100 to apply ties to different rod joints without requiring a different tie installing tool 100 for different joint dimensions. Rather, an appropriately dimensioned anvil assembly 214 or 314 must be attached to tie ejector 102 to result in a functional tool for installing ties to different sized rod joints. Although two removable anvil assemblies 214, 314 are illustrated, it will be understood that additional larger, smaller, taller, or wider anvil assemblies (not shown) may be provided to extend versatility of tie installing tool 100.

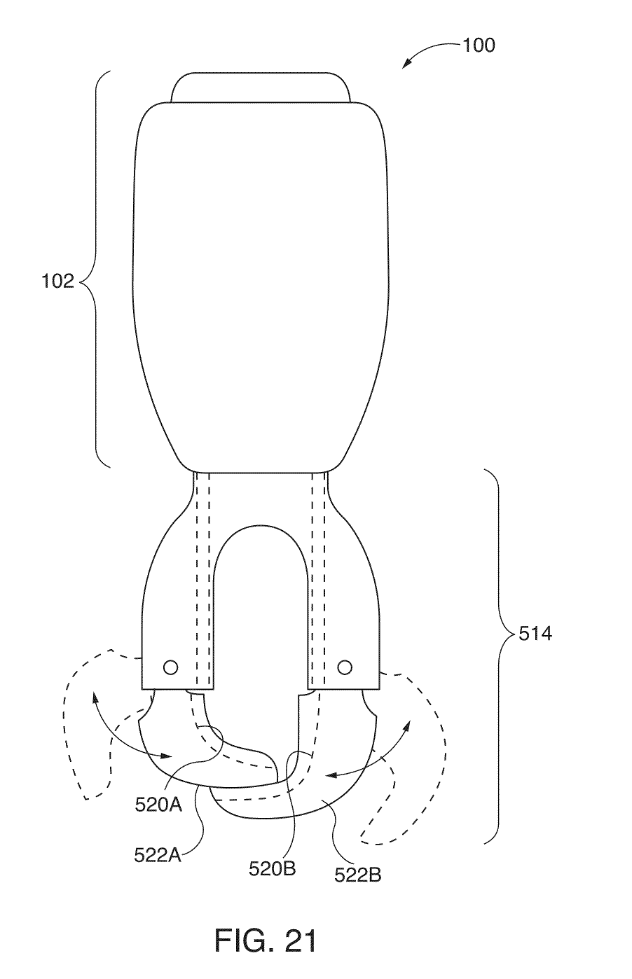

FIGS. 21, 22, and 23 show a tie installing tool 100 comprising a tie ejector 102 and an anvil assembly 514 attachably associated with tie ejector 102 (FIG. 1). Anvil assembly 114 may partially encircle the at least two crossed rods 2 in a deployed position, and may assume a released position (similar to that depicted in FIG. 1) enabling the at least two crossed rods 2 to disengage from tie installing tool 100. The difference between FIG. 1 and FIG. 21 is that in FIG. 21, jaws 522A, 522B of anvil assembly 514 are arranged such that jaw 522A overlies jaw 522B in the deployed position. By contrast, in FIG. 1, corresponding jaws 122A, 122B are side by side relative to one another (as seen in FIG. 2). In tie installing tool 100 of FIG. 21, grooves 520A, 520B need not be offset from one another, as occurs in the tie installing tool 100 of FIG. 1.

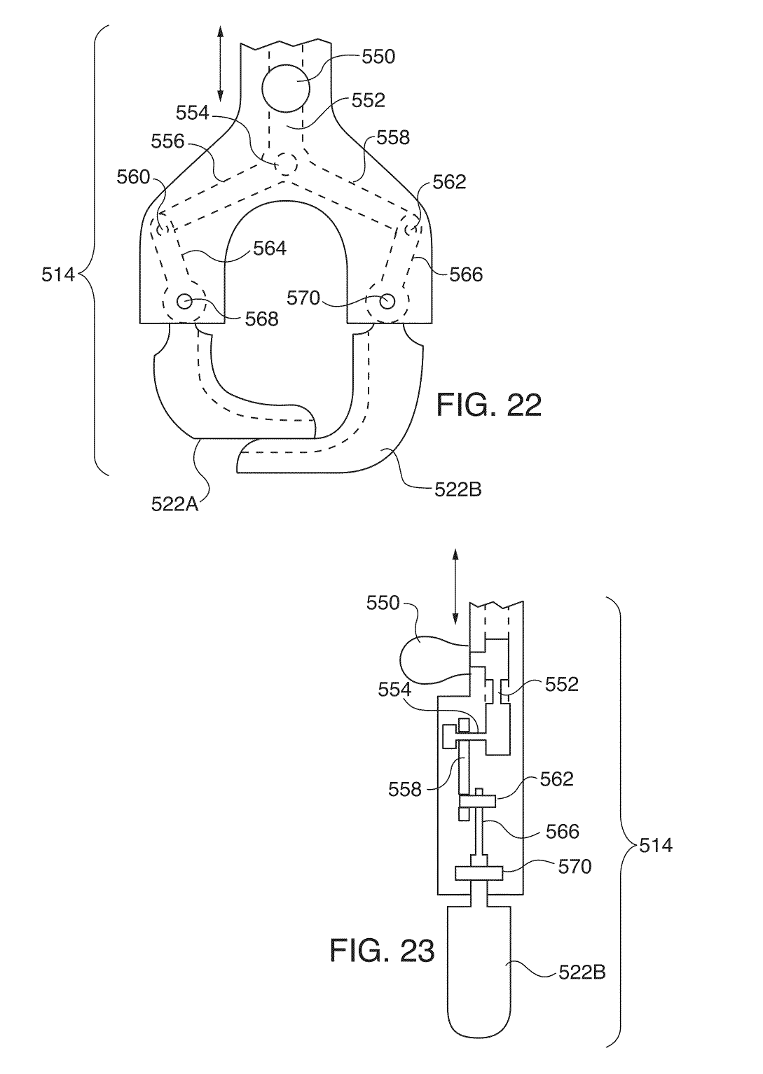

FIGS. 22 and 23 show an exemplary arrangement of arms and pivots enabling opening and closing of jaws 522A, 522B. A manual knob 550 is fixed to an arm 552, which arm 552 can translate upwardly and downwardly, as indicated by arrow A in FIG. 22. Responsively to upward and downward translation of arm 552, arms 556 and 558 pull or push on arms 564, 566. Arms 556, 558 are linked to arm 552 at a pivot pin 554. Pivot pin 554 and arms 556, 558 are not anchored to anvil assembly 514. Pivot pins 568, 570 are journaled within or otherwise supported to anvil assembly 514, so that jaws 522A and 522B, and their respective integral arms 564 and 566 pivot about pivot pins 568, 570. In summary, when knob 550 is pulled upwardly, as seen in FIGS. 22 and 23, arm 552 translates upwardly; arms 556, 558 are drawn such that pins 560, 562 are drawn in the direction of the center of FIG. 22; and jaws 522A, 522B spread apart to the position shown in dashed lines in FIG. 21. A spring (not shown) may be provided to urge jaws 522A, 522B into either the deployed position shown in FIG. 22 or the released position shown in dashed lines in FIG. 21.

In FIGS. 21 and 22, a portion of first jaw 522A and a portion of second jaw 522B are side by side when overlapping one another in the deployed position.

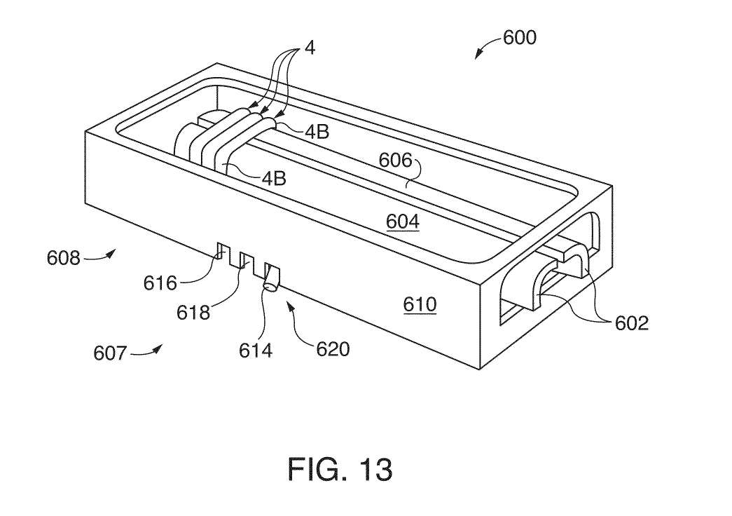

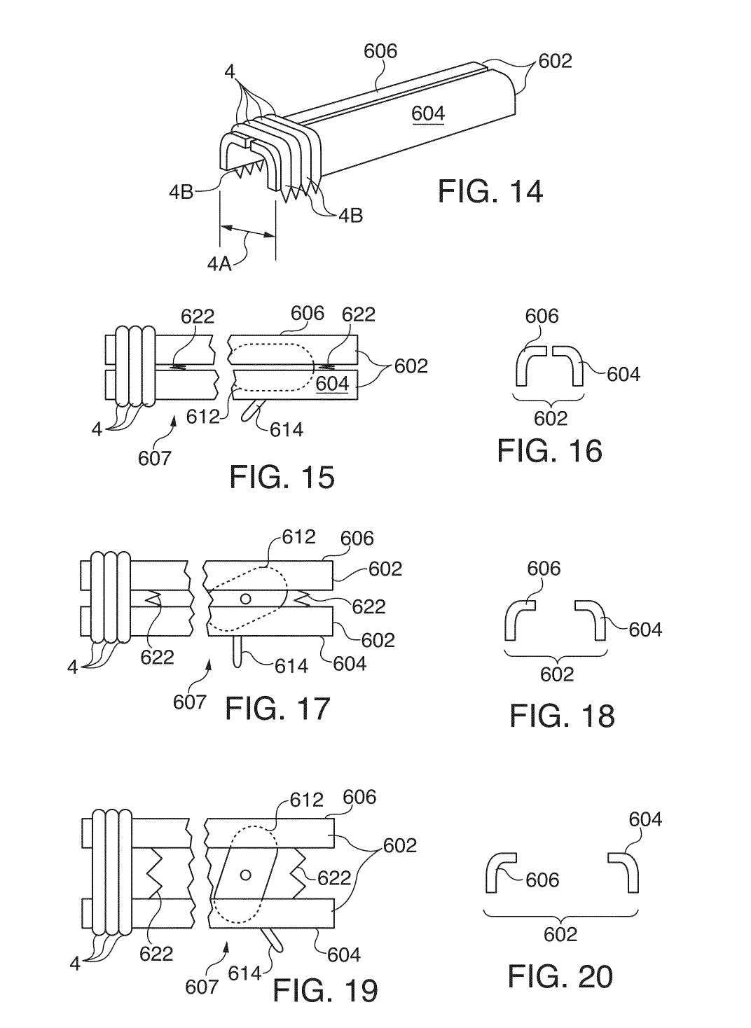

Referring to FIGS. 13-20, there is shown a magazine 600 for holding staples 4, wherein magazine 600 is adjustable to accommodate staples 4 of different widths. As employed herein, width of a staple refers to a distance 4A spanning the outermost opposed surfaces of the two legs 4B of staple 4.

Magazine 600 comprises a staple bed 602 formed in two sections 604, 606, and a spreading mechanism 607 (FIGS. 15, 17, 19) which is adjustable to vary distance between the two sections 604, 606. Spreading mechanism 607 may comprise a cam 612 which contacts and spreads the two sections 604, 606 apart, and a lever 614 accessible to finger access from outside magazine 600. Staple bed 602 conforms to the inner contour of staples 4, so that staples 4 can rest in close cooperation with staple bed 602, but can slide therealong. Ordinarily, a spring device (not shown) is provided to advance staples 4 towards the discharge end 608 of magazine 600 as staples 4 are ejected when tie installing tool 100 is used.

Staple bed 602 is seen from above in FIG. 15 and in end view in FIG. 16. Staple bed 602 is suitably supported within a housing 610 of magazine 600 (see FIG. 13) such that mirror image sections 604, 606 can spread apart from the relatively close mutual positioning shown in FIGS. 13-15. Referring particularly to FIG. 15, cam 612 is manually rotatable by lever 614 to rotate to urge mirror image sections 604, 606 apart. FIGS. 15, 17, and 19 respectively illustrate three degrees of spread, and corresponding movement of cam 612. Again referring to FIG. 13, lever 614 is selectively movable to and retained within any of three notches 616, 618, 620 in housing 610. When occupying any one notch 616, 618, or 620, lever 614 may be depressed until it clears the bounds of its notch 616, 618, or 620, and moved laterally to a different notch 616, 618, or 620. Mirror image sections 604, 606 are urged by return springs 622, 624 (FIGS. 16, 28, 20) to return to one of the three possible positions corresponding to positioning shown in FIGS. 13-15.

Unless otherwise indicated, the terms “first”, “second”, etc., are used herein merely as labels, and are not intended to impose ordinal, positional, or hierarchical requirements on the times to which these terms refer. Moreover, reference to, e.g., a “second” item does not either require or preclude the existence of, e.g., a “first” or lower-numbered item, and/or, e.g., a “third” or higher-numbered item.

Tie ejector 102 has thus far been described in terms of similarity to a staple gun. It would also be possible that tie ejector 102 could be similar to a nailing gun.

Tie installing tool 100 has been described in terms of overlapping of first and second jaws 122A, 122B. It would be possible that first and second jaws 122A, 122B abut, or alternatively, remain spaced apart in the deployed position, rather than overlap (these options are not shown).

It should be understood that the various examples of the apparatus(es) disclosed herein may include any of the components, features, and functionalities of any of the other examples of the apparatus(es) disclosed herein in any feasible combination, and all of such possibilities are intended to be within the spirit and scope of the present disclosure. Many modifications of examples set forth herein will come to mind to one skilled in the art to which the present disclosure pertains having the benefit of the teachings presented in the foregoing descriptions and the associated drawings.

Therefore, it is to be understood that the present disclosure is not to be limited to the specific examples presented and that modifications and other examples are intended to be included within the scope of the appended claims. Moreover, although the foregoing description and the associated drawings describe examples of the present disclosure in the context of certain illustrative combinations of elements and/or functions, it should be appreciated that different combinations of elements and/or functions may be provided by alternative implementations without departing from the scope of the appended claims.

I claim:

1. A tie installing tool for tying together at least two crossed rods arranged to be non-parallel and touching one another, the tie installing tool comprising:
a tie ejector comprising a holder for holding at least one tie having a first end and a second end, wherein the tie ejector which propels ties from the holder along an ejection axis towards the at least two crossed rods, and a trigger for actuating the tie ejector;
an anvil assembly attachably associated with the tie ejector, comprising a guide surface movable between a deployed position linearly aligned with the ejection axis of the tie ejector and partially encircling the at least two crossed rods, and a released position enabling the at least two crossed rods to disengage from the tie installing tool, wherein the guide surface is configured to deform a tie ejected from the tie ejector to fully encircle the at least two crossed rods; and
an actuator which moves the guide surface from the released position to the deployed position.

2. The tie installing tool of claim 1, wherein the anvil assembly comprises:
a first jaw pivotally mountable to the anvil assembly and bearing a first portion of the guide surface, and
a second opposed jaw pivotally mountable to the anvil assembly and bearing a second portion of the guide surface, wherein
the first jaw and the second jaw close over the at least two crossed rods in the deployed position.

3. The tie installing tool of claim 2, wherein the first jaw and the second jaw overlap one another in the deployed position.

4. The tie installing tool of claim 3, wherein a portion of the first jaw and a portion of the second jaw are side by side when overlapping one another.

5. The tie installing tool of claim 3, wherein a portion of the first jaw and a portion of the second jaw overlie one another in the deployed position.

6. The tie installing tool of claim 2, wherein
the first jaw has a first groove which
defines the first portion of the guide surface,
receives the first end of a tie being ejected from the tie ejector, and
deforms a first portion of the tie being ejected to curve around the at least two crossed rods; and
the second jaw has a second groove which
defines the second portion of the guide surface,
receives the second end of the tie being ejected from the tie ejector, and
deforms a second portion of the tie being ejected to curve around the at least two crossed rods.

7. The tie installing tool of claim 2, wherein the actuator includes a plunger which is displaced relative to the tie installing tool when the tie installing tool is pressed against at least one of the two crossed rods, and a linkage connected to the plunger control, the first jaw, and the second jaw, the linkage arranged to move the first jaw and the second jaw between the deployed position and the released position responsive to the plunger being displaced relative to the tie installing tool.

8. The tie installing tool of claim 1, wherein
the anvil assembly is a first anvil assembly and is removably mountable to the tie installing tool, the first anvil assembly having first capacity dimensions, and
the tie installing tool comprises at least one second anvil assembly having second capacity dimensions different from the first capacity dimensions of the first anvil assembly.

9. The tie installing tool of claim 1, further comprising a magazine for holding staples, wherein the magazine is adjustable to accommodate staples of different widths.

11. A magazine for holding staples, wherein the magazine has means for adjusting to accommodate staples of different widths.

12. The magazine of claim 11, further comprising a staple bed formed in two sections, and a spreading mechanism which is adjustable to vary distance between the two sections.

13. The magazine of claim 12, wherein the spreading mechanism comprises a cam which contacts and spreads the two sections apart, and a lever accessible to finger access from outside the magazine.
